(19) United States
(12) Patent Application Publication
(10) Pub. No.: US 2026/0245764 A1
(43) Pub. Date: Aug. 20, 2026

(54) CHARGED PARTICLE TRAP APPARATUS

(71) Applicant: Oxford Ionics Limited, Begbroke (GB)

(72) Inventors: Maciej MALINOWSKI, Begbroke (GB); David ALLCOCK, Begbroke (GB); Chris BALLANCE, Begbroke (GB)

(73) Assignee: Oxford Ionics Limited, Begbroke (GB)

(21) Appl. No.: 19/161,658

(22) PCT Filed: Feb. 29, 2024
(86) PCT No.: PCT/GB2024/050545

§ 371 Date: Sep. 2, 2025

(30) Foreign Application Priority Data
Mar. 2, 2023 (GB) 2303088.5

(51) Int. Cl. G21K 1/20

(52) U.S. Cl. CPC G21K 1/20

(57) ABSTRACT

A charged particle trap apparatus is disclosed. The apparatus comprises a charged particle trap including a set of electrodes for transporting charged particles. The apparatus comprises a plurality of voltage sources, each voltage source having a respective output. The apparatus comprises a set of switches. Each electrode in the set of electrodes is provided with a respective switch in the set of switches. Each switch in the set of switches is configured to selectably connect the electrode to the output of one of the voltage sources and at least two switches in the set of switches are configured to be selected together.

### FIELD

The present invention relates to a charged particle trap apparatus, such as a trapped charged particle quantum computer.

### BACKGROUND

Trapped-ion qubits are one of the most promising approaches to quantum computing. One of the advantages of using trapped-ion qubits is flexible connectivity. Specifically, qubit routing (that is, changing which qubit is coupled to which other qubits) can be accomplished by physically moving ions in space. This ability, combined with excellent coherence times, allows qubit routing with negligible errors even at large scales. Flexible qubit routing is the basis of the quantum charge-coupled device (QCCD) architecture, and is one of the reasons why trapped-ion systems allow for high quantum volumes. Reference is made to D. Kielpinski, C. Monroe, and D. J. Wineland, Nature 417, 709 (2002), number: 6890.

Flexible connectivity, however, comes at a cost. Fast, low-heating ion transport uses precise dynamical control of voltages on many electrodes.

FIG. 1 illustrates an approach to electrical wiring of trapped-ion quantum computers, for example, as described in J. M. Pino, J. M. Dreiling, C. Figgatt, J. P. Gaebler, S. A. Moses, M. S. Allman, C. H. Baldwin, M. Foss-Feig, D. Hayes, K. Mayer, C. Ryan-Anderson, and B. Neyenhuis, Nature 592, 209 (2021), arXiv:2003.01293 [quantph] and V. Kaushal, B. Lekitsch, A. Stahl, J. Hilder, D. Pijn, C. Schmiegelow, A. Bermudez, M. Müller, F. Schmidt-Kaler, and U. Poschinger, “Shuttling-Based Trapped-Ion Quantum Information Processing,” (2019), arXiv:1912.04712 [quant-ph]. This approach uses about ten electrodes per ion or qubit, each wired to a separate DAC outside of the vacuum system. This approach is not scalable with system size. For example, a 1,000-qubit chip would require approximately 10,000 analog input lines. Developing a reliable DAC-to-chip interface at this scale would be a major challenge in itself.

One solution that has been proposed and experimentally investigated is to form an integrated quantum processing unit (QPU), which combines an ion trap chip with digital to analogue converters (DACs) and reference is made to N. D. Guise, S. D. Fallek, H. Hayden, C.-S. Pai, C. Volin, K. R. Brown, J. T. Merrill, A. W. Harter, J. M. Amini, L. M. Lust, K. Muldoon, D. Carlson, and J. Budach, Review of Scientific Instruments 85, 063101 (2014), arXiv:1403.3662 [physics, physics:quant-ph]. Integration can be either monolithic, or achieved by packaging together several independently fabricated chips, for example, as described in R. Mahajan, Z. Qian, R. S. Viswanath, S. Srinivasan, K. Aygün, W.-L. Jen, S. Sharan, and A. Dhall, “Embedded Multidie Interconnect Bridge—A Localized, High-Density Multichip Packaging Interconnect” IEEE Transactions on Components, Packaging and Manufacturing Technology 9, 1952 (2019), conference Name: IEEE Transactions on Components, Packaging and Manufacturing Technology.

DAC integration, however, comes with several major challenges.

The first is power dissipation. Compact cryogenic DACs have been developed with power consumption of 30 mW per channel, or 300 W power for 1,000 qubits. While this can be optimised, DAC power dissipation presents significant challenges on the cryogenic system and thermal interfaces.

Second, DAC control requires streaming large volumes of data to the QPU. For example, in V. Kaushal ibid., each DAC require 5 MB/s of data input. For a 1000-qubit QPU, this corresponds to about 50 GB/s of data flow between the DAC and the controller. Designing an appropriate interface would not be trivial, and in practice would require integration of further electronics, for example, for waveform, compression, or the controller itself.

Thirdly, an integrated DAC typically occupies a much larger chip area than the electrode itself. For example, J. Stuart, R. Panock, C. D. Bruzewicz, J. A. Sedlacek, R. McConnell, I. L. Chuang, J. M. Sage, and J. Chiaverini, Physical Review Applied 11, 024010 (2019), arXiv:1810.07152 [physics, physics:quant-ph]describes a single, unfiltered DAC block with an area of 130 μm×270 μm. A lower noise controller is likely to have an even larger footprint, especially to accommodate integrated filters. Developing low-noise voltage sources areas comparable to top layer electrodes (for example, around 50 μm×50 μm) is a challenge in itself.

### SUMMARY

According to a first aspect of the present invention there is provided apparatus comprising a charged particle trap. The apparatus includes a set of electrodes for transporting charged particles, a plurality of voltage sources, each voltage source having a respective output, and a set of switches. Each electrode in the set of electrodes is provided with a respective switch in the set of switches. Each switch in the set of switches is configured to selectably connect the electrode (or “its respective electrode”) in the set of electrodes to the output of one of the voltage sources. At least two switches in the set of switches are configured to be selected together (in other words, are controlled as one).

Thus, the arrangement can be used to drive at least two electrodes at the same time and, therefore, provide parallel control of at least two electrodes.

The voltage source (or “waveform generator”) may comprise a DAC. The voltage source may be configured to output a time-varying signal for controlling transport of charged particle(s). At least some of the set of electrodes are configured along a section of a charged particle transport path between first and second ends such as that at least one electrode is disposed closer than another electrode to the first end.

At least some of the electrodes in the set of electrodes may form a contiguous section (or “zone”) of a charged particle transport path. At least some of the electrodes in the set of electrodes are spaced apart along a charged particle transport path. For example, the set of electrodes may be distributed between different, spaced-apart sections (or “zones”), for example, one electrode per zone. This can be used to implement parallel dynamic control using one switch per zone.

The electrodes in the set of electrodes at a first time may differ from the set of electrodes at a second, different time. The set of electrodes may comprise at least two electrodes.

Each switch in the set of switches may be configured to selectably connect the electrode to the output of one of two voltage sources. Each switch in the set of switches may be configured to operate as a single-pole, double-throw (SPDT) switch. Each switch in the set of switches may be configured to operate as a single-pole, multi-throw switch, such as a single-pole, three-throw switch (SPDT) switch. Each switch in the set of switches may be configured to selectably connect the electrode to the output of one of at least three voltage sources. Each switch in the set of switches may be configured to selectably connect the electrode to a terminal which is grounded, tied to a given voltage, or floating. All of the switches in the set of switches may be configured to be selected together.

The switches in the set of switches may be configured to be selected using a selection bit (s). For example, each switch may be configured to be selected using a respective selection bit.

The apparatus may further comprise a controller which is configured to output at least one selection signal to at least two switches in the set of switches.

The controller may be configured to output a selection signal to the switches in the set of switches. Thus, the same selection signal may be provided to the switches and be used to control the switches together. For example, there may be one select line which is connected to the switches such that setting a selection bit on the select line causes the switches to close.

The controller may be configured to output at least two selection signals, each selection signal provided to a respective switch. Thus, each switch may be provided with a respective signal and so separate selection signals can be used to control the switches. For example, there may be several select lines, each line connected to respective switch such that setting selection bits on respective select lines causes the switches to close. This can allow the set of electrodes to change dynamically.

The controller may be configured to output, at first time, at least two selection signals to at least two switches in a first set of switches and, at a second time, at least two selection signals to at least two switches in a second set of switches, wherein the first set of switches and the second set of switches differ by at least one switch. Expressed differently, which electrodes are selected together may change over time. For example, at first time step, first and second electrodes (for instance in first and second different zones, respectively) may be switched together and at a second time step, first and third electrodes (where the third electrode is different from the second electrode) may be switched together.

The controller may be configured to cause first and second charged particles lying in a path in the charged particle trap to be swapped.

The controller may be configured to cause first and second charged particles lying in a path in the charged particle trap to be swapped. The selection signal may be digital. Each selection signal may comprise a bit. A set of selection signals may comprise a word. The controller may be configured to output at least one selection signal so as to cause order of at least two charged particles lying in a path in the charged particle trap to be changed. Each of the plurality of voltage sources may be configured to output a predetermined waveform and the controller may be configured to output at least one selection signal so as to cause reconfiguration of at least two charged particles lying in a path in the charged particle trap.

The apparatus may comprise a first set of electrodes and a first set of switches, wherein each electrode in the first set of switches is provided with a respective switch in the first set of switches, and wherein at least two switches, optionally all of the switches, in the first set of switches are configured to be selected together. The apparatus may comprise a second set of electrodes and a second set of switches, wherein each electrode in the second set of switches is provided with a respective switch in the second set of switches, and wherein at least two switches, optionally all of the switches, in the second set of switches are configured to be selected together. At least one of the switches in the first set of switches and at least one of the switches in the second set of switches may be connected to the same voltage sources.

The electrodes in the first set of electrodes are preferably configured to cover a first contiguous section of the charge particle transport path and the electrodes in the second set of electrodes are preferably configured to cover a second, different contiguous section of the charge particle transport path.

The first and second contiguous sections may be adjacent sections of the charge particle transport path.

A first electrode in the first set of electrodes may be configured to be connectable to a one of a first voltage source or a second voltage source, and a first electrode in the second set of electrodes is configured to be connectable to a one of a first voltage source or a third voltage source.

The apparatus may comprise P sets of voltage sources, each set of voltage sources comprising Q voltage sources where P and Q each are positive, non-zero integers and each set of switches may be configured to switch between a first set of the P sets of voltage sources and a second set of the P sets of voltage sources so as to connect a set of Q electrodes to either the first set of P voltage sources or to the second set of the P sets of voltage sources.

Each of the voltage sources may be configured to output a time-varying signal waveform. Each of the voltage sources may be configured to output a respective smooth waveform for holding a charged particle at a given position or for moving a charged particle from a first position to second position along a transport path.

The set of electrodes may comprise at least 3 electrodes. The set of electrodes comprises no more than 40 electrodes. The set of electrodes may comprise between 3 and 40 electrodes.

The apparatus may comprise at least 50 electrodes (which may include the set of electrodes or more than one set of electrodes). The apparatus may comprise no more than 1,000,000 electrodes. The apparatus may comprise between 50 and 1,000,000 electrodes.

Each electrode may be layer-like having a thickness, and wherein each electrode may have at least one dimension (such as width, or width and length, or diameter) perpendicular to the thickness between 10 μm and 2,000 μm. The electrode may be polygonal, for example, rectangular.

The apparatus may comprise a charged particle trap chip, the charged particle trap and the switches may be monolithically integrated on the charged particle trap chip. The apparatus may comprise a charged particle trap chip and at least one further chip (or wafer) stacked on the charged particle trap chip, and the switches may be integrated into the at least one further chip. The voltage sources may be integrated on the charged particle trap chip or the at least one further chip.

The apparatus may comprise a transport controller which is configured to control the switches in the set of switches. The transport controller may be a classical computer system, such as a desktop computer, comprising a at least one processor and memory.

The apparatus may be a quantum computer. The apparatus may be an atomic clock.

The set of electrodes may be transport electrodes and the plurality of voltage sources may be a plurality of transport voltage sources. The set of trap electrodes may further include a set of shim electrodes for generating electric fields for manipulating charged particles and the apparatus may further comprise a shim voltage source having an output. The apparatus may further comprise a demultiplexer having an input and a plurality of outputs, wherein the output of the shim voltage source is coupled to the input of the demultiplexer, and each of the plurality of outputs of the demultiplexer are coupled to a respective one of the set of shim electrodes. The demultiplexer may be configured, in a first phase (or “period”), to charge the shim electrodes sequentially and, in a second phase (or “period”), to be disconnected from the shim electrodes for a given time for providing a lower noise environment in which operations can be performed on the charge particles.

Using a demultiplexer can allow significantly fewer voltage sources can be used while arranging for the demultiplexer to be disconnected can help to reduce or even avoid introducing noise resulting from using a demultiplexer. The electrodes in the set of electrodes can be used to compensate for local stray fields.

According to a second aspect of the present invention there is provided apparatus comprising a charged particle trap. The charged particle trap includes a set of electrodes for generating electric fields for manipulating charged particles. The apparatus comprises a voltage source having an output and a demultiplexer having an input and a plurality of outputs, wherein the output of the voltage source is coupled to the input of the demultiplexer, and each of the plurality of outputs of the demultiplexer are coupled to a respective one of the set of electrodes. The demultiplexer is configured, in a first phase, to charge the electrodes sequentially and, in a second phase, to be disconnected from the electrodes for a given time for providing a lower noise environment in which operations can be performed on the charge particles.

Using a demultiplexer can allow significantly fewer voltage sources can be used while arranging for the demultiplexer to be disconnected can help to reduce or even avoid introducing noise resulting from using a demultiplexer. The electrodes in the set of electrodes can be used to compensate for local stray fields.

The apparatus may further comprise at least one further electrode coupled to the demultiplexer, wherein the demultiplexer is configured, in the second phase, to be connected to the at least one further electrode.

The apparatus may further comprise a set of capacitors, wherein each electrode in the set of electrodes is provided with a respective capacitor arranged between the electrode and ground.

The apparatus may comprise a charged particle trap chip, supporting the charged particle trap, wherein the capacitors are monolithically integrated on the charged particle trap chip. The apparatus may comprise a charged particle trap chip, supporting the charged particle trap and at least one further chip stacked on the charged particle trap chip, wherein the capacitors are integrated into the at least one further chip. The voltage source may be integrated on the charged particle trap chip or the at least one further chip.

The given time may be sufficient to perform a series of at least one quantum gates. Thus, the given time may be between 1 μs and 1 s.

The given time may be sufficient to transport at least one charged particle from a first arrangement of charged particles to a second, different arrangement of charged particles. Thus, the given time may be between 1 ms and 500 ms (for example, in the case where charged particles are transported between quantum gates) or between 1 μs ms and 1,800 s (for example, in cases where the apparatus is not used for quantum gates). The given time may be between 60 s and 1,000 s.

Each electrode may be layer-like having a thickness, and wherein each electrode may have at least one dimension perpendicular to the thickness between 10 μm and 2,000 μm.

The apparatus may further comprise a shim controller, wherein the shim controller is configured to cause charging of the electrodes in the set of electrodes. The shim controller may be configured to cause charging of the electrodes in the set of electrodes to respective levels appropriate to compensate for stay electric fields. The shim controller may be a classical computer system, such as a desktop computer, comprising at least one processor and memory.

The apparatus may be a quantum computer. The apparatus may be an atomic clock.

According to a third aspect of the present invention there is provided a system comprising the apparatus and a cryogenic system for cooling at least the charged particle trap.

According to a fourth aspect of the present invention there is provided a method of operating the apparatus the method comprising, causing an order of at least two charged particles lying in a path in the charged particle trap to be changed including causing at least two switches in the set of switches to be switched together.

The method may comprise causing, in a first phase, the demultiplexer to charge the electrodes sequentially and causing, in a second phase, demultiplexer to be disconnected from the electrodes for a given time for providing a lower noise environment in which operations can be performed on the charge particles.

According to a fifth aspect of the present invention there is provided a method of operating the apparatus the method comprising, causing, in a first phase, the demultiplexer to charge the electrodes sequentially and causing, in a second phase, demultiplexer to be disconnected from the electrodes for a given time for providing a lower noise environment in which operations can be performed on the charge particles.

### BRIEF DESCRIPTION OF THE DRAWINGS

Certain embodiments of the present invention will now be described, by way of example, with reference to FIGS. 2 to 19 of the accompanying drawings, in which:

FIG. 1 schematically illustrates electrical wiring of trapped-ion quantum computers;

FIG. 2 schematically illustrates electrical wiring of a trapped-ion quantum computer employing a switch network and a demultiplexing network and using dynamic electrodes and shim electrodes;

FIG. 3 schematically illustrates an array of electrodes which can be configured to provide electrodes of different shapes and/or for different purposes;

FIG. 4 schematically illustrates a charged particle above an electrode;

FIG. 5A schematically illustrates a first, simple parallel control arrangement;

FIG. 5B schematically illustrates a second, simple parallel control arrangement;

FIG. 5C schematically illustrates a third, more complex parallel control arrangement;

FIG. 5D schematically illustrates a fourth, more complex parallel control arrangement;

FIG. 5E schematically illustrates a fifth, more complex parallel control arrangement;

FIG. 6A schematically illustrates before and after a so-called “switchable swap” involving two qubits in neighbouring zones;

FIG. 6B schematically illustrates a parallel odd swap in a linear one-dimensional qubit array in which qubits in six of the eight zones undergo swap operations, while qubits in two zones remain stationary;

FIG. 7 schematically illustrates two-dimensional ion swaps in a 4×4 ion trap;

FIG. 8A schematically illustrates one-dimensional physical swap for two neighbouring qubits in a one-dimensional trap or in a two-dimensional trap segment without junctions between the qubits;

FIG. 8B schematically illustrates a two-dimensional physical swap for two neighbouring qubits sharing a junction;

FIG. 9 schematically illustrates an extended 1D swap waveform;

FIG. 10 schematically illustrates single-switch implementation of parallel digital control;

FIG. 11A schematically illustrates a switch system for controlling a dynamic electrode;

FIG. 11B is a circuit schematic showings implementation of an SPDT switch in eth system shown in FIG. 8A using two transistors in a pass configuration;

FIG. 11C is a circuit schematic showings implementation of an SPDT switch in eth system shown in FIG. 8A using two transmission gates;

FIG. 12 schematically illustrates multi-switch implementation of parallel dynamic control;

FIG. 13 schematically illustrates two-dimensional trap with four qubits per junction;

FIGS. 14A and 14B shows plots of reconfiguration time and number of time steps and of associated memory error, in a worst-case scenario, for reconfiguring a two-dimensional trap array of qubits in a so-called “optimal configuration” assuming swap time of t₀=100 μs;

FIG. 15 schematically illustrates an example of an architecture of shim demultiplexing in which shim electrodes are connected one-by-one to voltage sources via demultiplexers;

FIG. 16 schematically illustrates an analog shim demultiplexer based on a multi-stage network of switches;

FIG. 17 schematically illustrates a hybrid shim demultiplexer implementation;

FIGS. 18A to 18E schematically illustrate different methods of implementing single-qubit and multi-qubit quantum gates; and

FIG. 19 schematically illustrates an example of electrical wiring of a 1,000-qubit chip in which a quantum processing unit requires only about 200 electrical inputs to control 1,000 qubits.

### DETAILED DESCRIPTION OF CERTAIN EMBODIMENTS

### I. Introduction

Embodiments of ion trap wiring approaches are herein described which allow fast and arbitrary qubit routing with low number of control lines. As an example, a 1000-qubit chip is demonstrated which can be controlled with about 200 input lines and minimal on-chip power dissipation.

In a quantum charge-coupled device (QCCD), electrodes can serve two different purposes. The first is dynamic, namely to deliver time-varying waveforms which execute the desired transport primitives, such as shuttling, merging, splitting or crystal rotations. The second is quasi-static, namely to compensate stray electric fields, generated for example by local charges. Typically, each electrode serves both purposes. In the approach herein described, each electrode is explicitly assigned to be either dynamic or quasi-static.

Two techniques are employed, namely (1) dynamic electrode parallelisation wherein dynamic electrodes are co-wired to a fixed number of voltage sources assigned potentially through integrated switches, and (2) quasi-static electrode demultiplexing wherein quasi-static electrodes (herein referred to as “shim electrodes”) are controlled through a small number of voltage sources through integrated demultiplexers. The voltage sources may include or take the form of digital-to-analog converters (DACs).

In the approaches herein described, instead of voltage source integration, switch integration is used. Unlike voltage sources, switches and demultiplexers require very small data input rates, and can be operated with negligible power dissipation. Furthermore, switches and demultiplexers are relatively simple structures, made of a small number of transistors and inverters. Thus, they can be readily fabricated in a CMOS process, and can be cryogenically compatible.

In the approaches herein described, dynamic operations are massively parallelised across the processor. This decreases operation flexibility, but significantly eases the control requirements. As will be explained hereinafter, instead of needing about 10 voltage sources per qubit, about 100 of these voltage sources suffice regardless of the processor size. Shim electrodes require local voltage tuning, so they cannot be driven in parallel. However, since they do not require dynamic tuning, an electrode can be set to the target voltage and then disconnected from the voltage source. This allows one voltage source to serve multiple shim electrodes. As will be explained in more detail hereinafter, one voltage source should suffice to serve in the region of 100 to 1000 electrodes. Thus, at 2 to 10 shim electrodes per qubit, the approach allows for about 10 to 500 qubits per voltage source.

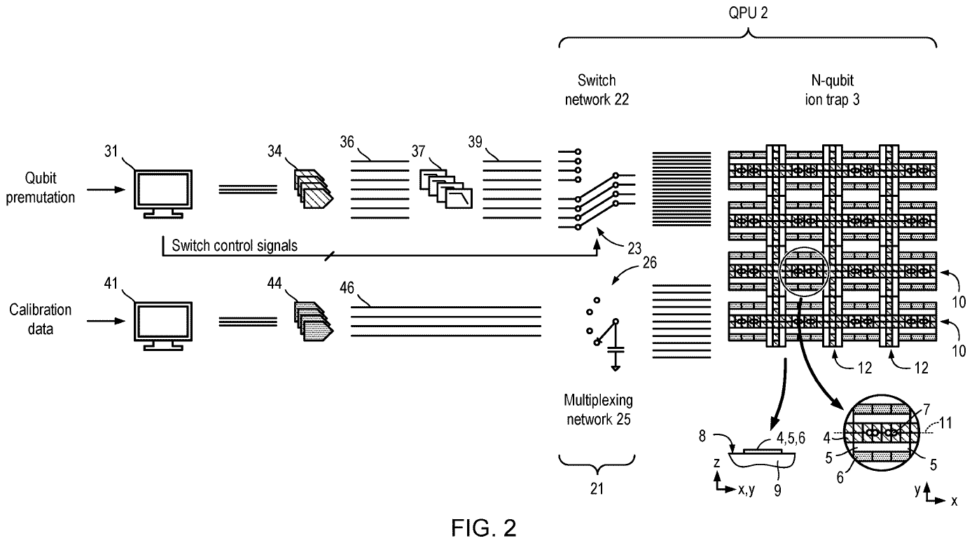

Referring to FIG. 2, a quantum computing system 1 is shown which incorporates a chip wiring architecture.

The quantum computing system 1 comprises a QPU 2 which includes an N-qubit ion trap 3 comprising dynamic electrodes 4 (or “dynamic electrodes”), rf electrodes 5 and quasi-static electrodes 6 (or “shim electrodes”) for controlling charged particles 7 which in this case take the form of ions, such as ⁴³Ca⁺ ions. The charged particles may, however, take the form of atoms or molecules, each with a net electric charge, electrons or positrons.

The electrodes 4, 5, 6 are generally supported on a principal surface 8 of a substrate 9. However, at least some of the electrodes may be buried and, as will be explained in more detail later, components such as capacitors, switches (formed by transistors), and interconnects may be buried.

In this example, the dynamic electrodes 4 run in pairs in rows 10 along central axis 11 and singly in columns 12 crossing the rows 10. The rf electrodes 5 run along outer edges of the rows 8 and the quasi-static electrodes 6 run along the outer edges of the rf electrodes 6.

The electrodes 4, 5, 6 may have other different configurations. For example, the dynamic electrodes 4 need not be formed between the rf electrodes 5 and the quasi-static electrodes 6. The electrodes 4, 5, 6 need not be rectangular and need not be the same shape.

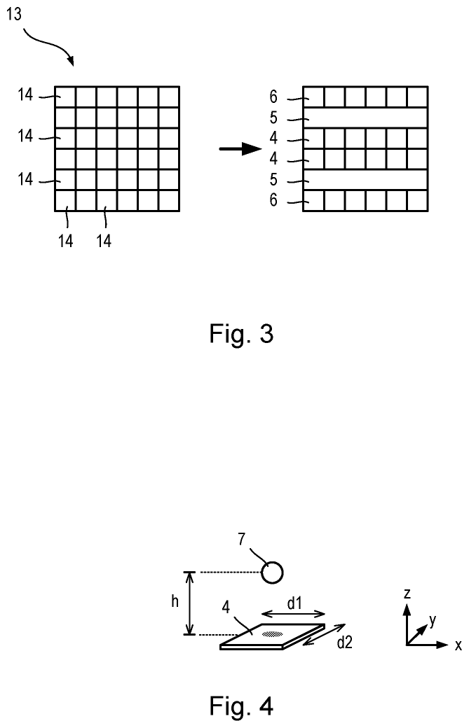

Referring to FIG. 3, the electrodes 4, 5, 6 may be provided by an array 13 of blank electrodes 14 and the function of each electrode 14 is defined or programmed by control electronics.

Referring also to FIG. 4, the trap 3 is configured to hold charged particles 7 at a height h above the surface 15 of the trap 3. Electrodes 4 used for the transporting charged particles 7 (such as the dynamic electrodes 4) may have a lateral dimension d₁, d₂ (such as width or length) which is approximately the same as the height h. The height h may be, for example, between 5 μm to 2 mm, or between 10 μm and 200 μm. Thus, the electrodes 4 may have a width d1 of between 5 μm to 2 mm, or between 10 μm and 200 μm.

Referring again to FIG. 2, the QPU 3 includes a switch/demultiplexing network 21 comprising a switch network 22 which comprises a plurality of switches 23 and switch lines 24, and a demultiplexing network 25 which comprises a plurality of demultiplexes 26 and demux lines 27.

A transport controller 31, in the form of a computer system, receives qubit permutation and outputs transport control signals to transport voltage sources 34, for example, comprising digital-to-analog converters (DACs), which generate signals which are provided to first transport control lines 36. The first transport control lines 36 are provided with corresponding filters 37 and filtered signals are provided to second transport control lines 38 which are coupled to the switch network 22.

A shim controller 41, in the form of a computer system, receives calibration data and outputs control signals to shim voltage sources 44, for example, comprising DACs 44, which generate signals which are provided to shim control lines 46.

In this example, for transport control, there are about 10N which lines (where Nis the number of qubits, in this case, about 1,000), 100 transport DACs 34, about 100 first transport control lines 36, about 100 filters 37, about 100 second transport lines 39, and for shim control, there are between 3N and 10N demux lines 27, between (N/300) and (N/10) shim DACs 44 and between (N/300) and (N/10) shim control lines 46.

The trap 3 and optionally some other parts of the system 1 may be housed in a cryogenic refrigerator (not shown) for cooling the trap 3 to a suitably low temperature T (e.g., below 77 K or 4.2 K). The trap 3 may be housed in a vacuum chamber (not shown), which provides an ultra-high vacuum environment allowing individual charged particles to be isolated.

Herein, the term “qubits” tends to be used rather than “ions”. Thus, when referring to a physically movement of a qubit, for example, “a qubit is moved around”, this physically corresponds to shuttling one or more ions that encode that qubit, as well as potentially ancilla ions that serve to re-cool it.

The chip wiring architecture will now be described in more detail.

First, parallelising dynamic control will be described including examples of how parallel dynamic control is used and qubit routing methods compatible with parallel control. Then, demultiplexed shim operation will be described including an example implementation.

### II. Parallel Dynamic Control

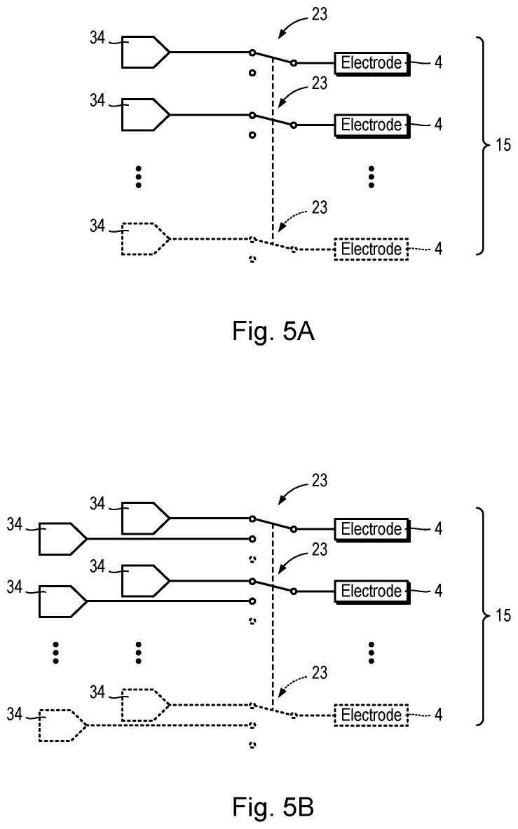

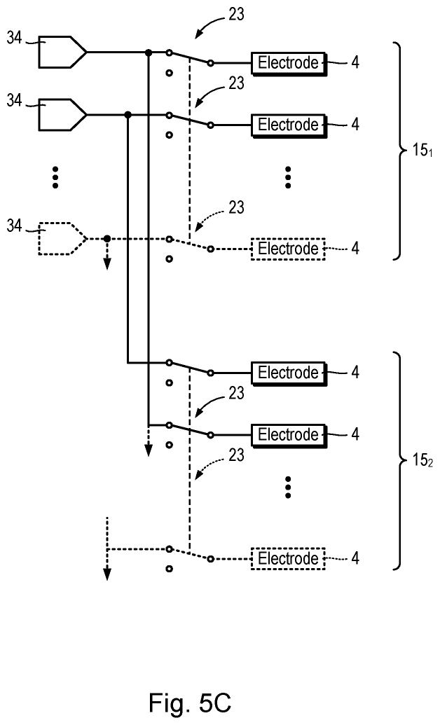

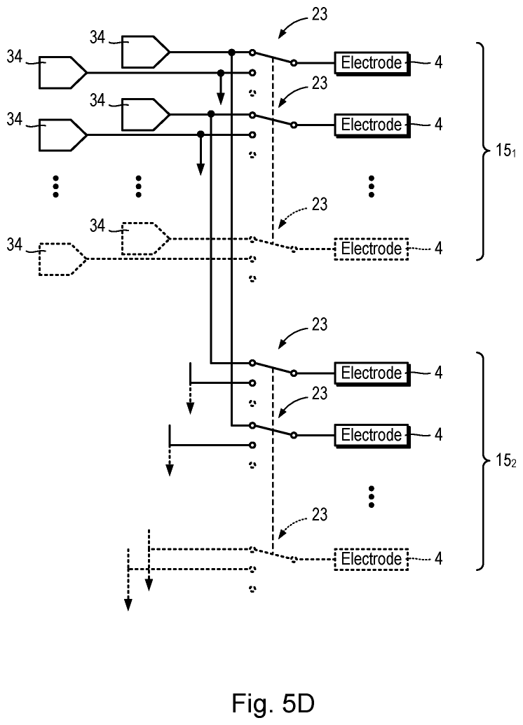

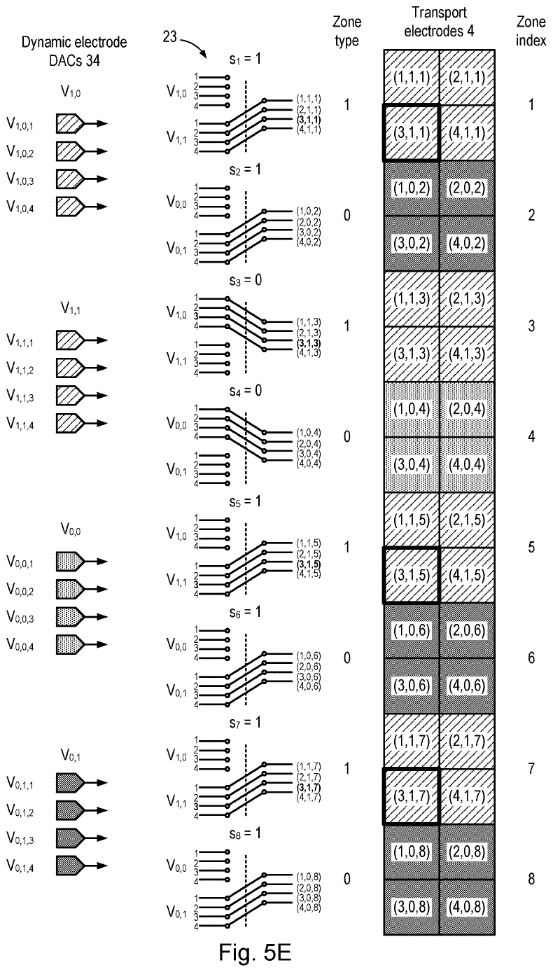

Referring to FIG. 5A, a first parallel control arrangement for a group 15 of transport electrodes 4 is shown.

Each dynamic electrode 4 is provided with a respective switch 23 (either as a single-pole, single-throw switch or a single-pole, double-throw switch) which is configured to selectably connect the electrode 4 to the output of a transport voltage source 34 (for example, a DAC). In this case, each electrode 4 is provided with a respective transport voltage source 34. More than one electrode 4 may, however, share the same voltage source 34. The electrodes 4 and the switches 23 are located on chip. The voltage source 34 is preferably located off-chip, although it may be located on-chip.

For a group 15 of dynamic electrodes 4, switches 23 are configured to be selected or operate together, in other words, to close together (and thus connect all the electrodes 4 in the same group to voltage sources 34) and to open together (and thus, all the electrodes 4 in the group are disconnected from the voltage source 34). Expressed differently, the switches 23 can be seen to operate together as a multiple-pole, single-throw switch or a multiple-pole, double-throw switch.

The switches 23 can be controlled using one control signal for example by a single control bit, s. For example, when s=1, each switch 23 is closed and, thus, each electrode 4 is connected to the output of a voltage source 34, and when s=0, the switch is open and, thus, each electrode 4 is unconnected to the output of a voltage source 34 or vice versa.

Referring to FIG. 5B, a second parallel control arrangement is shown.

The second parallel control arrangement is the same as the first parallel control arrangement shown in FIG. 5A, except that it includes a second set of transport DACs 34 and each switch is a multi-throw switch with one terminal connected to a first transport voltage source 34 and another terminal connected to a second transport voltage source 34. In this case, each electrode 4 is provided with two respective transport voltage sources 34. More than one electrode 4 may, however, share the same voltage source 34.

The switches 23 can be controlled by a single control bit, s. For example, when s=1, an electrode 4 is connected to one voltage source 34, and when s=0, the electrode 4 is connected to a another, different voltage source 34.

In some cases, the switches may have a third terminal allowing an electrode 4 to be connected to one of two voltage sources 34, or be unconnected.

More complex parallel control arrangements can be used.

Referring to FIG. 5C, a third parallel control arrangement is shown.

The third parallel control arrangement is similar to the first parallel control arrangement shown in FIG. 5A, except that there are first and second groups 15₁, 15₂ of electrodes 4 which share the same set of transport voltage sources 34. For example, a first electrode 4 in the first group 15₁ and a second electrode 4 in the second group 15₂ may share the same voltage source 34. Although electrodes 4 in one group 15₁, 15₂ can be switched together, each group 15₁, 15₂ of electrodes can be switched independently of the other group 15₁, 15₂.

There may be more than two groups 15 of electrodes 4, and the output of a voltage source 34 can be shared between more than group 15. Furthermore, the output of a voltage source 34 can be shared between more than one electrode 4 in one group 15. The output of a voltage source 34 may not be shared between all groups 15.

Referring to FIG. 5D, a fourth parallel control arrangement is shown.

The fourth parallel control arrangement is similar to the second parallel control arrangement shown in FIG. 5B, except that there are first and second groups 15₁, 15₂ of electrodes 4 which share the same set of transport voltage sources 34. For example, a first electrode 4 in the first group 15₁ and a second electrode 4 in the second group 15₂ may share the same voltage source 34, while a second electrode 4 in the first group 15₁ and a first electrode 4 in the second group 15₂ may share another voltage source 34.

As in the third parallel control arrangement, electrodes 4 in one group 15₁, 15₂ can be switched together, while each group 15₁, 15₂ of electrodes can be switched independently of the other group 15₁, 15₂.

Also as in the third parallel control arrangement, there may be more than two groups 15 of electrodes 4, and the output of a voltage source 34 can be shared between more than group 15. Furthermore, the output of a voltage source 34 can be shared between more than one electrode 4 in one group 15. The output of a voltage source 34 may not be shared between all groups 15.

Referring to FIG. 5E, a fifth parallel control arrangement is shown.

This arrangement shows that the output of one voltage source can shared between electrodes 4 between different groups 15 (or “zones”), while inside one group 15 (“zone”), each electrode 4 is connected to a different voltage source 34. In this arrangement (which is simplified for ease of understanding), there are four electrodes per zone 15. There may, however, be more electrodes 4 per zone.

In this arrangement, electrodes 4 are labelled using the notation (electrode index, zone type, zone index).

FIG. 5E illustrates how the same voltage source can be shared between different electrodes in different zones, while electrodes in the same zone can be controlled in parallel. For example, voltage source labelled “V_{1,1,3}” is shared between the third electrode in zone 1 (the electrode labelled (3,1,1)), the third electrode in zone 5 (the electrode labelled (3,1,5)) and the third electrode in zone 7 (the electrode labelled (3,1,7)) and so on.

A simple of example of how parallel dynamic control is used will first be described to help provide a better understanding of parallel dynamic control.

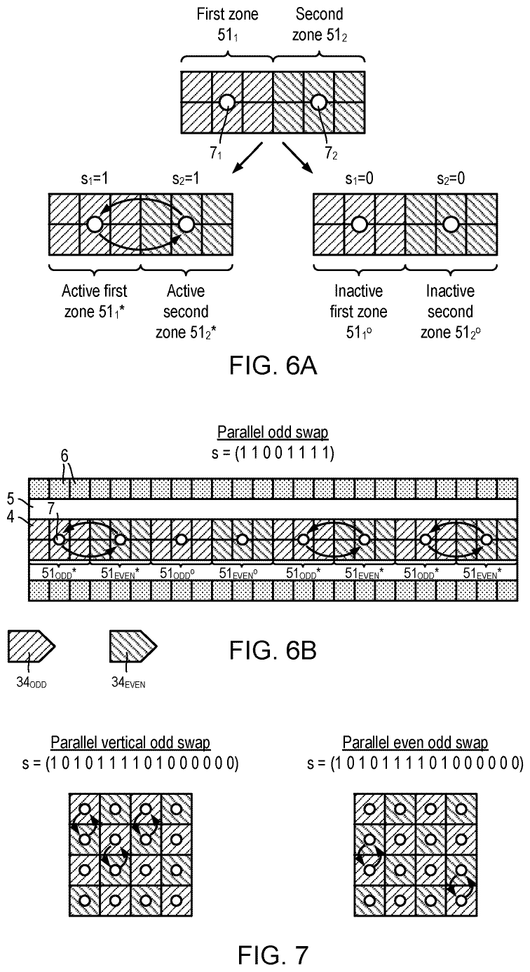

Referring to FIG. 6A, two qubits (1,2) (labelled 7₁, 7₂) are in neighbouring trap zones 1, 2 (also labelled 51₁, 52₂).

Qubit swap can be accomplished by connecting all electrodes to a set of voltage sources 34 (FIG. 2) that execute a swap waveform. If a swap is not needed (that is, if the qubits are to be kept stationary), then one approach is simply to modify the voltage source waveforms. Instead, however, according to the approach in accordance with the invention, the swap waveform continues to be played from (or “generated by”) the voltage sources, but a set of switches 23 (FIG. 2) in the QPU 2 is used to select whether or not the ions 7 move. Specifically, action in zone i is controlled by a digital line sᵢ. If sᵢ=1, the qubit in zone i experiences the swap waveform, while if sᵢ=0, then the qubit stays stationary. Thus, in a two-zone trap, qubits are swapped if (s₁, s₂)=(1, 1), and remain in the same order if (s₁, s₂)=(0, 0). It should be noted that in this case, (0, 1) and (1, 0) are not valid instructions.

Referring to FIG. 6B, the processor may be scaled up to be a linear repeating array with zones i=1, 2, . . . , N, in this case, with N=6. Every second zone is connected to the same fixed set of voltage sources, that is, if sᵢ=sᵢ+2, then every dynamic electrode in zone i+2 executes the same waveform as the corresponding dynamic electrode in zone i. Thus, by applying the same swap waveform as above, and sending an N-bit word s=(s₁, s₂, . . . , s_{N}) to the QPU, it is possible to select whether or not to swap qubits (i, i+1) for every odd i in parallel. This step is referred to an “odd swap”. Similarly, an “even swap”, where it is selected whether or not to swap qubits (i, i+1) for every even i in parallel, can be accomplished by playing a modified swap waveform and sending another N-bit word s.

Thus, arbitrary parallel qubit swaps can be achieved in one dimension (1D) with a fixed number of voltage sources 34 and an N-bit digital signal. In 1D, two types of zones 51_{ODD}, 51_{EVEN} are used, namely odd and even zones 41_{ODD}, 41_{EVEN}, and two sets of voltage sources 34_{ODD}, 34_{EVEN} are employed, namely one for odd zones, and one for even zones.

Referring to FIG. 7, if every zone is connected via a transport path to its four neighbours to provide a cross-shaped junction, this approach can be extended to a two-dimensional (2D) array. In such a 2D array, an “odd horizontal swap” and an “even horizontal swap” can be executed in the same way as described earlier for a 1D array.

Vertical swaps can be executed by first tilting the view 90 degrees. In Section IID below, how these primitives allow for efficient arbitrary qubit reconfiguration will be shown.

A 2D processor may be more complex. For example, it may be beneficial to separate gate zones from junction zones, or create specialised readout zones or storage zones. Nonetheless, parallel dynamic control can also be applied. For example, as will be described hereinafter in Section II D, traps with separate junction and gate zones can be controlled by using eight sets of voltage sources instead of four, hereinbefore described. All in all, parallel dynamic control is compatible with a complex processor and specialised zones, as long they consist of a repeating pattern of nominally identical unit cells. Likewise, the approach can be extended beyond swaps onto a larger set of parallel primitive actions by using more voltage source sets and more switch settings per zone.

### A. Swap Waveforms

While the logical primitive of the architecture is a qubit swap, this is not necessarily the physical primitive. There are several ways that qubit swap can be implemented physically.

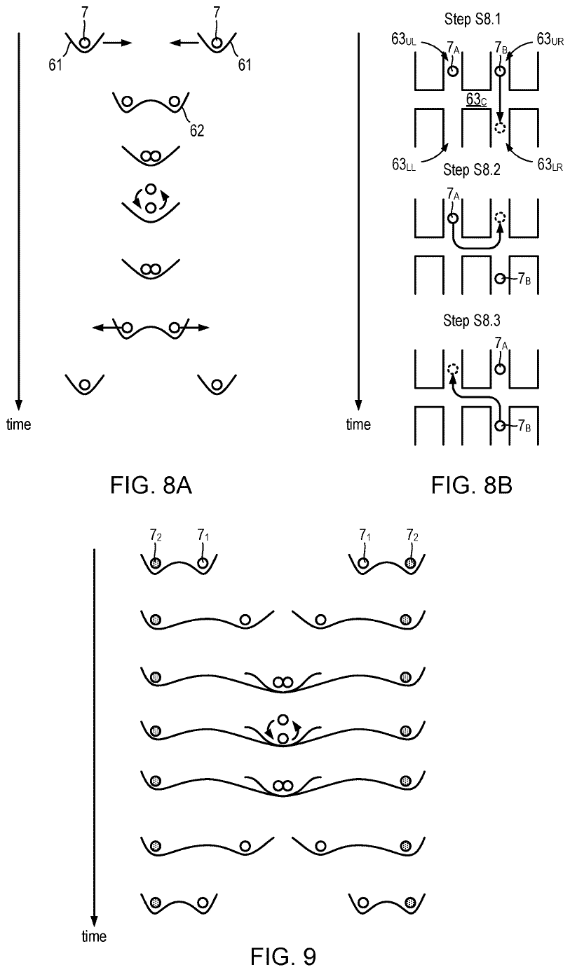

Referring to FIG. 8A, a 1D physical swap sequence is illustrated. Two qubits 7 in separate wells 61 are brought together by shuttling and merged into a single crystal 62. Next, the crystal undergoes rotation that swaps the qubit order. Reference is made to H. Kaufmann, T. Ruster, C. T. Schmieglow, M. A. Luda, V. Kaushal, J. Schulz, D. von Lindenfels, F. Schmidt-Kaler, and U. G. Poschinger, Physical Review A 95, 052319 (2017). Finally, the crystal is split, and the qubits are shuttled away from each other.

Referring to FIG. 8B, a 2D physical swap sequence is illustrated which can be used when a junction 53 is present. By using a junction, two qubits 7 can be reordered in several steps of shuttling, without the need for crystal rotations (steps S8.1 to S8.3). This can be advantageous in terms of speed and heating. Finally, logical swaps can be implemented through quantum gates. This can lead to additional errors, but may allow for faster reconfiguration, especially in longer chains.

First and second qubits 7A, 7_{B} are located in adjacent first and second channels 63_{UL}, 63_{UR} which lie across from third and fourth channels 63_{LR}, 63_{LL}, respectively, joined by a common central channel 63_{C}. The second qubit 6_{B} can be shuttled to the fourth channel 63_{LR} lying opposite (step S8.1). The first qubit 7_{B} is shuttled to the second channel 63_{UR} to take its place (step S8.2). The second qubit 7_{B} can be shuttled to the first channel 63_{UL} to take the place of the first qubit (step S8.3).

While the swap waveforms above assume all qubits start in separate zones, this need not be the case. For example, consider an initial configuration where N qubits are arranged in chains of length 2c, where c is a positive, non-zero integer. Before the routing begins, a sequence of c splitting waveforms is applied in every pair of zones until every qubit is placed in a separate zone. The procedure is repeated in reverse after the routing to bring the qubits together and apply the next layer of gates. More complex procedures can be used to control other chain lengths. The algorithm is also flexible with regards to ancilla handling. For example, every qubit could represent a pair of ions, namely one qubit ion and one ancilla ion. In that case, primitive operations could involve 4-ion crystal rotations or 2-ion junction shuttling.

Transport waveforms are determined using an electrostatic model of the charged particle trap. A path for a charged particle from an initial position x₁ to an end position x_{N} is provided (e.g., from a routing module) and is divided into intermediate positions x₁, x₂, . . . , x_{N}. The electrostatic model of the trap is used to compute the electrostatic potential generated by putting a fixed voltage, for example, 1V on each electrode individually. Then, for each i (i.e., i=1, 2, . . . , N), an optimisation algorithm is run that computes a linear combination of electrode voltages that generates a potential that holds an ion at location xᵢ. Finally, the obtained voltage (i.e., computed linear combination of electrode) are interpolated to generate a smooth waveform. An example of determining waveforms and examples of waveforms obtained in this way can be found in L. E. de Clercq: “Transport Quantum Logic Gates for Trapped Ions” (2015) https://www.research-collection.ethz.ch/handle/20.500.11850/111463 (see for example, FIGS. 6.4, 6.5 and 6.6) which is incorporated herein by reference. Another method can be found, for example, in J. D. Sterk et al. “Closed-loop optimization of fast trapped-ion shuttling with sub-quanta excitation”, npj Quantum Information (2022) 8:68 https://www.nature.com/articles/s41534-022-00579-3.pdf

### B. Single-Switch Implementation

Referring to FIG. 9, an extension of the 1D swap waveform between zones (1, 2) is shown. First qubits 7₁ undergo a swap and second qubits 7₂ remain stationary.

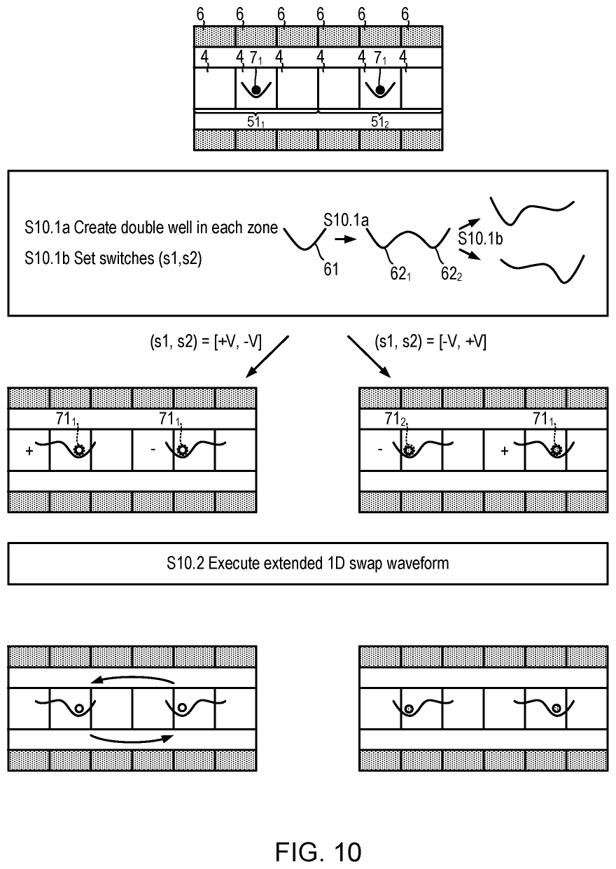

Referring to FIG. 10, an alternative way to use this waveform is as follows.

Suppose that there are only two qubits 7₁, 7₂, namely one in a first zone 51₁ (“zone 1”), and another in a second zone 52₂ (“zone 2”). A switchable push field can be used to push qubits 7₁, 7₂, in each zone 51₁, 51₂ either left or right. Specifically, if sᵢ=1, the qubit in zone i is pushed into a first respective location 71₁, while if sᵢ=0, it is pushed into a second respective location 71₂. After the switch is set, the waveform is executed. Thus, if (s₁, s₂)=(1, 1), the qubits undergo a swap, while if (s₁, s₂)=(0, 0), they remain in the original order.

This swap waveform can be physically implemented as follows.

The fixed voltage sources are used to execute the extended swap waveform in every zone in parallel. At the same time, in each zone, whether the ion 7₁, 7₂ is pushed into the second or first well 62₂, 62₁ at t=0 can be selected by (a) creating a double-well potential while (step S10.1a) (b) applying either positive voltage +V or negative voltage −V to one or more electrodes (step S10.1b). This allows one to locally and digitally select if the ion undergoes a swap or not. Thus, one switch per zone suffices to implement parallel dynamic control. The same method can be used to condition the execution of a 2D swap waveform. Steps S10.1a and S10.1b can be carried out sequentially or simultaneously.

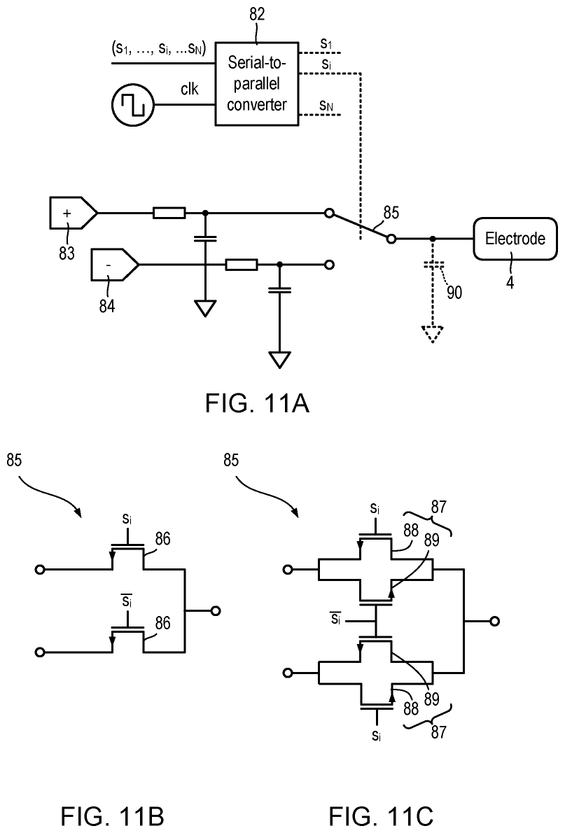

Referring to FIG. 11A, an example of a switch system 81 is shown. The select bit word s=(s₁, . . . , s_{N}) is loaded into a serial-to-parallel register 82, and is used to select whether zone i is connected to the +rail 83+ or −rail 84 using a selection switch 85.

Referring also to FIGS. 11B and 11C, the selection switch 85 can be physically implemented using a pair of pass transistors 86, or as two transmission gates 87, each implemented using an NMOS/PMOS transistor pair 88, 89 and an inverter.

In one embodiment, the ±rails 83, 84 connect to separate voltage sources 34 (FIG. 2) and are initially set to the same voltage V₀. Once each electrode 4 is connected to one rail 83, 84, the voltage on the +rail 83 is increased to V₀+V, and the voltage on the −rail 84 is reduced to V₀−V. This ramping can be done smoothly to avoid undesired motional excitation, with voltage source outputs filtered off-chip. After all electrodes 4 are set to either V₀+V or V₀−V, the swap waveform is played, and the rails 83, 84 return to V₀. This implements one cycle of parallel swaps.

Alternatively, parallel switching can be implemented by purely digital means. In this method, the ±rails 83, 84 are permanently set to V₀±V. This can considerably simplify circuit design, and make it compatible with standard digital CMOS. However, digital implementation may require capacitors after the switches 85 to smooth out the switching impulses. Alternatively, qubits can be displaced with minimum motional excitation and without filtering by a sequence of switching events using bang-bang methods.

In relation to capacitive shunting of the electrodes to ground, while technologies exist to manufacture low-loss switches with R<10Ω resistance, transistor switches with R≈100Ω are more typical. The larger the resistance R, the larger the RF pickup on the dynamic electrodes.

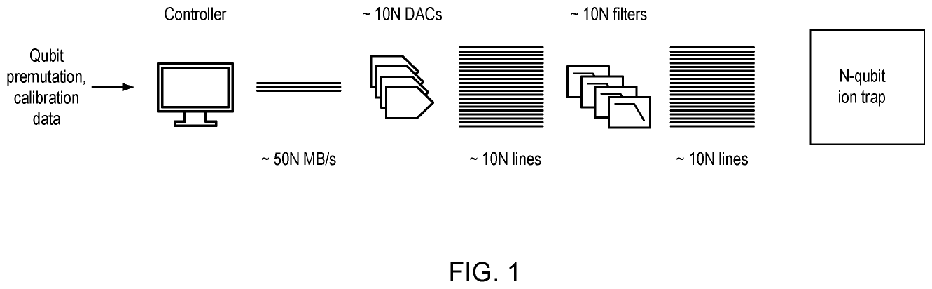

Referring still to FIG. 1A, this pickup can be mitigated by placing a shunt capacitor 90 between the switch 85 and the electrode 4. However, significantly reducing the RF impedance to ground requires large capacitors, for example, example, at Ω_{RF}=2π×50 MHz, an impedance Z<10Ω requires capacitance C>300 pF. Implementing such large capacitors on the chip likely requires significant footprint and vertical capacitor technology (as explained in Section III A). Furthermore, such on-chip filtering also means the total capacitive load of each voltage source may vary significantly sequence-to-sequence, leading to waveform distortions. Thus, it is preferable overall to filter signals off-chip, and reduce the transmission gate resistance if necessary.

### C. Multi-Switch Implementation

In the multi-switch implementation, multiple or all dynamic electrodes 4 (FIG. 2) in every zone are connected to a switch.

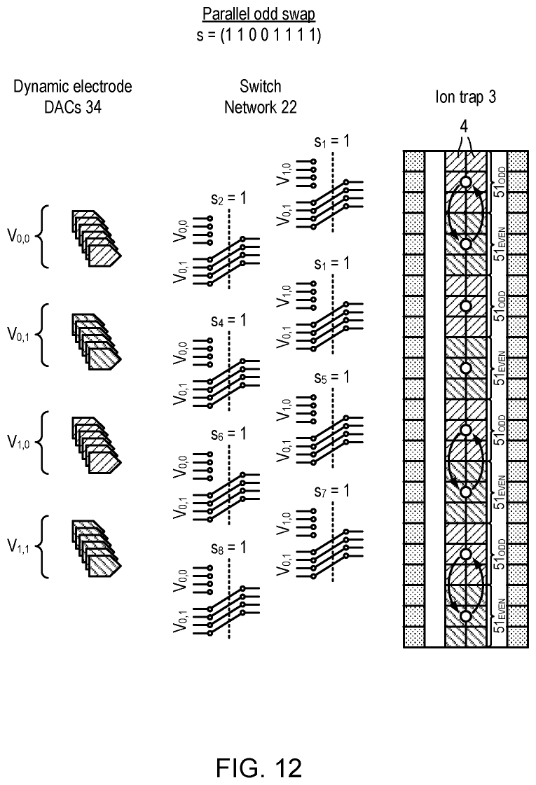

FIG. 12 illustrates a possible multi-switch implementation of a single parallel odd swap in 1D described earlier with reference to FIG. 6B.

Referring to FIG. 12, a zone i (labelled 52) is called odd (52_{ODD}) if i is odd, and even (52_{EVEN}) otherwise. Every dynamic electrode 4 in zone i is controlled by the same switch sᵢ. Specifically, dynamic electrodes 4 in zone i are connected to the voltage source set V_{f(mod 2),si}. Thus, the illustrated implementation requires four sets of voltage sources 34 and at 6 dynamic electrodes 4 per zone, and so 24 voltage sources 34 in total are used.

More generally for N zones, t zone types, e switchable dynamic electrodes per zone, each connected to a switch with k settings, multi-switch implementation requires t×e×k voltage sources and N×e on-chip switches. Each electrode 4 is individually wired as in the single-switch implementation.

The multi-switch implementation allows for maximum flexibility in the waveform design, as every action can have a completely separate custom waveform. As all the switches in zone i are controlled by the same digital line sᵢ, the length of the bit select word s is still N.

### D. Routing Algorithm

As explained earlier, parallel dynamic control allows implementation parallel “odd swaps” and parallel “even swaps” in a 1D array. In a 2D array, those can be performed either on all rows in parallel (“horizontal odd/even swap”) or on all columns in parallel (“vertical odd/even swap”). In this section, how this capability allows for arbitrary qubit routing in a complex trap will be explained.

As the simplest case, consider a 1D trap described with reference to FIG. 6B. In this case, arbitrary qubit permutation can be optimally generated by an algorithm known as “odd-even sort”. Denote the current qubit configuration as \vec{x}=(x₁, x₂, . . . , x_{N}), and the target configuration as π(\vec{x})=(π(x₁), π(x₂), . . . , π(x_{N})). In the first time step, qubits xᵢ and xᵢ₊₁ swapped if π(xᵢ)>π(xᵢ₊₁) for every odd i. These swaps are performed in parallel across the processor. In the second time step, qubits xᵢ and xᵢ₊₁ swapped if π(xᵢ)>π(xᵢ₊₁) for every even i.

These steps are repeated until \vec{x}=π(\vec{x}). The odd-even sort is the time-optimal method of sorting qubits in 1D, with worst-case run time of N time-steps (in the case where two qubits at the opposite ends need to be swapped).

Next, the method can be extended onto a 2D architecture described with reference to FIG. 8B. Reference is made to N. Alon, F. R. K. Chung, and R. L. Graham, SIAM Journal on Discrete Mathematics 7, 513 (1994), A. M. Childs, E. Schoute, and C. M. Unsal, 24 pages (2019), arXiv:1902.09102 [quant-ph] and A. Banerjee, X. Liang, and R. Tohid, “Locality-aware Qubit Routing for the Grid Architecture,” (2022), arXiv:2203.11333 [quant-ph].

Consider a grid of m×n qubits arranged in a 2D array, and enumerate zones as (i, j), where i=1, 2, . . . , m and j=1, 2, . . . , n. A zone is considered “odd” if i+j is odd, and “even” otherwise. In this way, every odd zone only neighbours even zones, and vice versa. Qubit reconfiguration as follows.

First, rearrange the qubits in every row in parallel such that, for every column, the target row of every qubit is different. This is possible by repeated application of Hall's marriage theorem. This rearrangement proceeds by horizontal odd even swap as outlined above, and thus takes at most m time-steps. Afterwards, rearrange the qubits in every column in parallel such as every qubit is in the target row. This is executed by vertical odd-even swap, and takes at most n time steps. Finally, proceed with the final row-wise rearrangement, which takes at most n time steps. Thus, the architecture allows for arbitrary permutation of N=m×n qubits in 2D in at most 2m+n swap steps and two types of zones. Changing the permutation order to column-row-column allows for arbitrary permutation in at most 2n+m steps, which may be more efficient

The considerations above assume every qubit can be swapped with any of its four neighbours, that is, one junction per qubit. However, junctions take up real estate, and high-performance quantum processors may benefit from higher qubit density. Thus, it may be beneficial to operate with multiple qubits per junction.

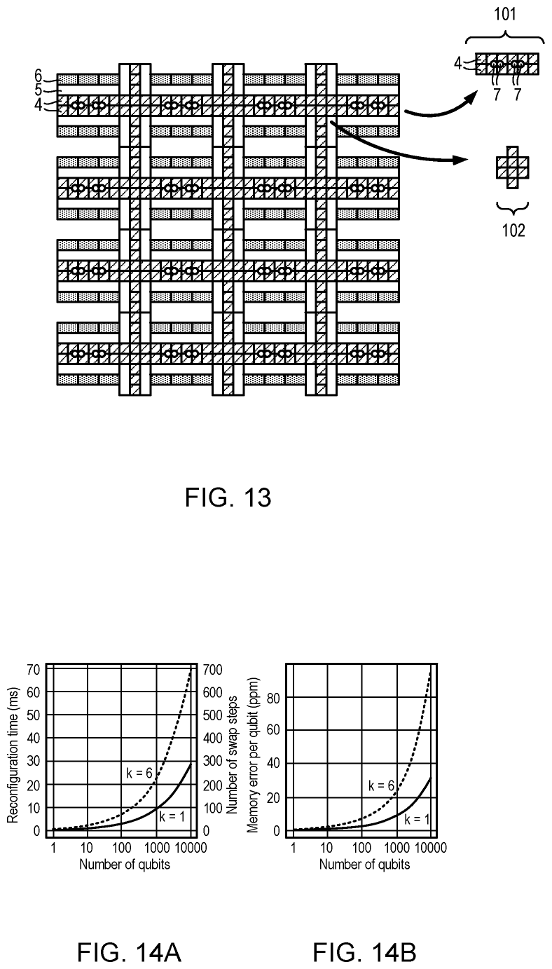

Referring to FIG. 13, a trap 3 is shown which illustrates one possible solution. The chip of linear segments 101, each holding k qubits. Between every k qubits, there is an X-junction 102.

Arbitrary routing in such a processor can be achieved by extending the methods hereinbefore described. Unlike previous examples with two types of zones, there are four types of zones, namely junction odd, junction even, inner odd, and inner even.

In the first step, the qubits are arranged in each row in parallel as before. Additional zone types are required, as the physical waveform necessary to control qubits is different depending on whether it is in a junction zone 102 or an inner zone 101. Second, qubits are sorted vertically in every junction zone in parallel. Afterwards, the qubit is swapped in each junction zone with its immediate neighbour to the right, and repeat the vertical sorting. This procedure is repeated k times, until all columns have been sorted. Thus, the only difference with the fully-connected 2D case is that the “vertical sort” step takes approximately k×m steps, rather than m steps as before. Finally, the horizontal sort is repeated as before. In total, arbitrary permutation of an array with m×n qubits takes approximately 2m+kn steps, using four types of zones.

Given any given (N, k) it is easy to verify that the reconfiguration time is minimised when m=\sqrt{KN/2} and n=\sqrt{2N/k}. In that case, arbitrary reconfiguration of an N-qubit array requires approximately \sqrt{8 kN} swap steps. This solution is referred to as the “optimal configuration”, and is discussed in more detail below.

### E. Performance and Timing

The total duration of qubit permutation depends on the time it takes to execute a single step of parallel swaps. This, in turn, depends on the duration of other primitives, such as ion splitting, merging, rotation, linear shuttling (in case of a 1D swap) or junction shuttling (in case of a 2D swap). As an order of magnitude, a qubit swap duration of to =100 μs is used, which is realistic given typical performance of existing systems.

Referring to FIG. 14A, the time necessary to perform arbitrary qubit routing in an optimal 2D array is shown (using that assumption). With k=6, an arbitrary reconfiguration of a 1000-qubit array is achieved in 22 ms, while 10,000 qubits takes 70 ms.

Referring to FIG. 14B, is plot showing associated memory errors, assuming the error model measured for ⁴³Ca⁺ clock qubits in M. A. Sepiol, A. C. Hughes, J. E. Tarlton, D. P. Nadlinger, T. G. Ballance, C. J. Ballance, T. P. Harty, A. M. Steane, J. F. Goodwin, and D. M. Lucas, Physical Review Letters 123, 110503 (2019), arXiv:1905.06878 [quant-ph]. With k=6, a memory error (per qubit per reconfiguration) of 2e-5 for a 1000-qubit array is expected, and 1e-4 for a 10,000-qubit system. This demonstrates that, despite limited freedom of operation, parallel dynamic control is compatible with fast, high-fidelity reconfiguration at scale.

In the analysis above, only the worst-case reconfiguration time is calculated. It is reasonable to ask whether a typical reconfiguration time will be substantially different.

Numerical analysis indicates that, for a random qubit permutation matrix, the average reconfiguration time is very close to the worst-case reconfiguration time. This is particularly true for large 2D arrays, as the time necessary to perform parallel horizontal/vertical sort is given by the time necessary to sort the slowest row/column. Thus, significantly reducing the reconfiguration time requires considerable amount of structure in the permutation matrix, that is careful qubit mapping in the algorithm.

### III. Demultiplexed Shim Operation

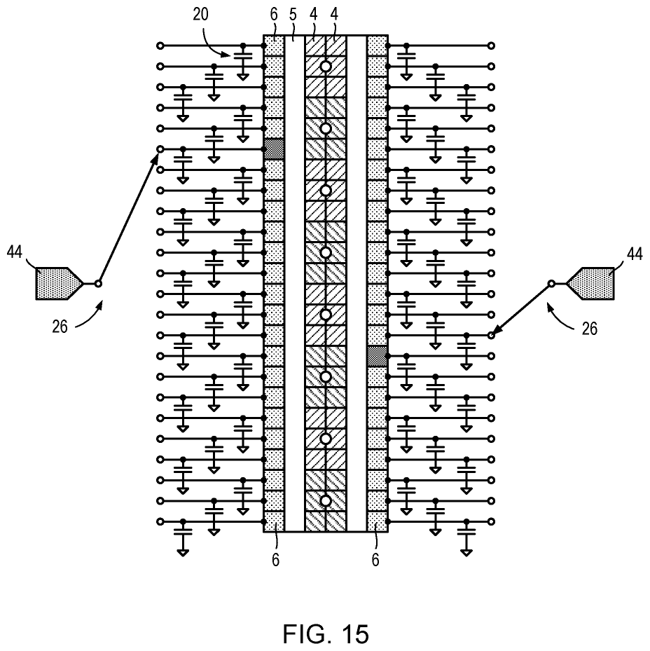

Referring to FIG. 15, the principle underlying demultiplexed shim operation is that multiple shim electrodes 6 can be set by a single voltage source 44.

In particular, one voltage source 44 is connected through a demultiplexer 26 to multiple shim electrodes 6. Naive demultiplexing, however, risks degrading the performance of quantum operations due to noise injection. The risk can be mitigated or ameliorated by operating by (1) charging the electrodes 6 one-by-one, (2) turning off the demultiplexer 26 and (3) executing quantum operations. Thus, during reconfiguration, the shim voltage is maintained not by the voltage source 44, but by on-chip capacitors 20, which also serve to shunt RF pickup to ground. These capacitors 20 may be unnecessary if the ion trap is ac Penning trap, rather than an RF trap.

### A. Shim Capacitors and RF Pickup

Suppose that i^{th} shim electrode 6 is set to Vᵢ. There may be residual RF voltage on the shim electrode, which can be particularly significant when the electrode 6 is disconnected from the voltage source 44. Suppose that shim electrodes 6 are shunted to ground through capacitance C. When the switch is open, the voltage on the shim electrode is Vᵢ+V_{RF}×Cᵢ/C cos(Ωt), where Ω is the RF frequency V_{RF} is the voltage on the RF electrode, and Cᵢ is a parasitic capacitance between the RF and the DC electrode. This leads to additional micromotion, especially if there are variations of C/C between electrodes. From this perspective, it is desirable to keep C very large.

As every shim electrode 6 has its own capacitor 20, these are integrated into the QPU 2 (for example, on-chip or co-packaged in a stacked structure) to avoid interconnect count. Once the capacitors 20 are integrated, the maximum value of C may be limited by chip footprint constraints. As an example, consider a device with ion height h and zone area A_{z}=10h×10h. Each zone contains Nₛ shim electrodes, each connected to a capacitor of area A_{c}. As long as Nₛ×A_{c}<A_{z}, the capacitors 15 do not represent a significant bottleneck on the device size. Thin-film planar capacitors allow for C/A~3 fF/μm². Thus, a capacitor C with dimensions A_{c}=100 μm×100 μm provides a capacitance of C~30 pF. Assuming h=30 μm, it is possible to connect Nₛ=10 shims per zone to such capacitors without bottlenecking the device footprint. Given a typical parasitic capacitance between the RF and the shim electrode of ~1 fF, this reduces the RF pickup by a factor of ~3×10⁻⁵. This should allow for good operations, especially that the pickup will be largely uniform across the chip. Nonetheless, parasitic capacitances can also be managed.

If necessary, RF pickup can be further reduced by using larger values of C. There are several ways this can be accomplished on-chip. First, larger planar capacitors can be used. For example, achieving C~300 pF with Nₛ=10 requires an area of ~1 mm² per zone. This means that a chip with N=10, 000 qubits would have to be attached to a 10 cm×10 cm capacitor die. More practically, multiple planar capacitors can be placed on different layers of the same chip. For example, using a 10-layer process, the effective C/A can be increased to ~30 fF/μm², allowing for shim capacitance of C~300 pF without increasing the footprint. Finally, vertical fabrication of trench capacitors allows for C/A~10 fF/μm² or even C/A~100 fF/μm².

### B. Demultiplexer Implementation

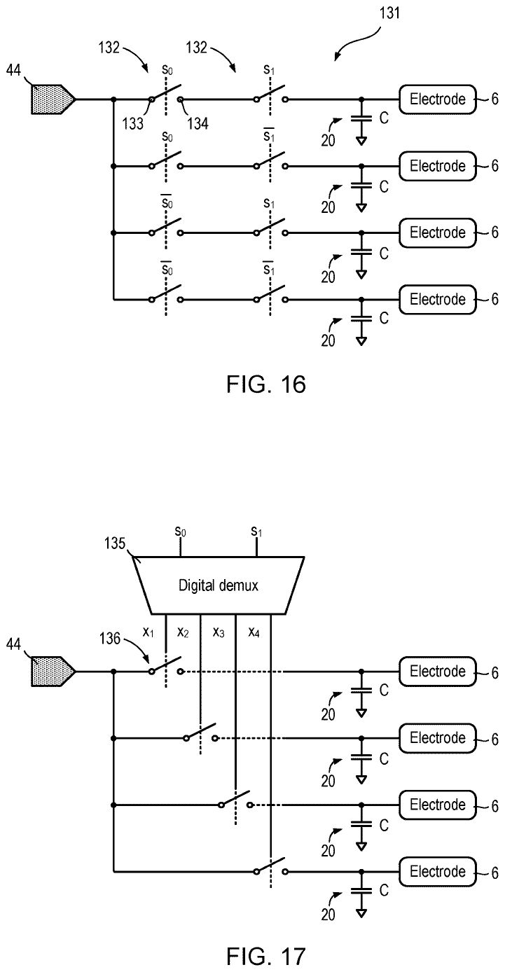

Referring to FIG. 16, a shim demultiplexer 26 can be implemented as a multistage switch network 131. The network 131 comprises a set of individual switches 132 arranged in pairs between the voltage source 44 and a respective electrode 6. A switch 132 connects the input 133 to the output 134 when s=1, and leave them disconnected otherwise. The individual switches 132 can be implemented, for example, as transmission gates (similar to those hereinbefore described).

In this configuration, a digital word s=(s₁, s₂, . . . , sₖ) of length k controls which one of 2k electrodes is connected to the voltage source voltage V. The word s can be sent to the chip either through a parallel interface, in other words, k cables, a serial interface 19 (FIG. 2), or generated on-chip using a flip-flop circuit that cycles through the switch settings in a fixed order.

Referring to FIG. 17, as an alternative, hybrid implementation, the switch can be separated into digital and analog parts.

First, a word s is sent to a digital demultiplexer 135. This selects which one of the 2^{k} lines x₁, x₂, . . . , x₂ₖ is pulled up, while the rest are set to ground. Second, for each i=1, 2, . . . , 2k, electrode i is connected to the shim voltage source 44 via a single switch 136 controlled by xᵢ. Thus, the demultiplexer 135 serves to connect one and only one of the shim electrodes to V.

There are two advantages of the hybrid implementation. First, the digital demultiplexer 135 is straightforward to design and fabricate. Second, the analog signal V need only to pass through a single switch 136, regardless of how many electrodes are connected to the same source. This helps reduce potential time-dependent issues associated with transmission gates, such as due to resistive load or charge injection.

### C. Electrode Charging

Before reconfiguration, electrodes 6 are charged to the correct voltage. While switching speed is fundamentally limited by the filter function of the switch resistance and the load capacitance, in practice it might be desirable to reduce the switching rate to reduce noise and ion motional excitation.

A transmission gate may have a resistance of R=100Ω and an on-chip capacitor may have a capacitance of C=30 pF. Thus, on-chip components act as a low-pass filter with cut-off frequency f_{c}=53 MHz, which is large compared to typical motional frequencies of trapped ions (f=1-10 MHz). Thus, charging the electrodes 5 using smooth waveforms for several microseconds can help to avoid significant motional excitations, while simultaneously avoiding bandwidth limitations imposed by the on-chip load.

In the following, it is assumed that a charging sequence takes t=3 s per electrode. Using k=7, it is possible to charge M×2k=M×128 electrodes using M voltage sources in 2k×t=380 μs. Thus, the time necessary to charge shim electrodes 6 is comparable to the time necessary to execute three to four swaps. Therefore, if needed, the electrodes 6 can be recharged between every reconfiguration layer, without significantly affecting the runtime. As will explained later, recharging shim electrodes 6 between every reconfiguration layer can be used to implement parallel gate operations. If it is not necessary to do so, it might be sufficient to recharge shim electrodes 5 much less frequently, for example, once per quantum circuit shot. In that case, it should be possible to serve many more electrodes 6 from a single voltage source 44.

One challenge of demultiplexed operation is charge injection. Once the electrode 6 is charged to voltage V, when the switch 132, 136 is open, the residual charge on the switch is injected into the electrode 6. In a simple model, each transistor switch stores charge Q=Cₜ (V_{g}−Vₜₕ−V), where Cₜ is the transistor gate-source capacitance, V_{g} is the gate control voltage, and Vₜₕ is the transistor threshold voltage. This charge is equally redistributed between the source and drain, hence the electrode voltage increases by ΔV=Q/C=(V_{g}−Vₜₕ−V)×Cₜ/C after the source is disconnected. Assuming V_{g}−Vₜₕ−V~V, the resulting voltage is systematically offset by ~V×Cₜ/C.

In this model, charge injection is a local systematic offset that is expected to be stable shot-to-shot, and thus can be calibrated out, even in the presence of variations between channels. Nonetheless, since no physical process is perfectly stable, it is desirable to minimise the systematic shift in the first place. The primary way of reducing charge injection systematic is by decreasing switch capacitance. Single-transistor switches having a transistor gate-source capacitance Cₜ~20 fF and even as low as ~1 fF are possible.

### D. Electrode Discharging

While voltage V would ideally stay constant after the switch is disconnected, it actually decays over time. The main loss channels are due to current flow through the capacitor and the transistor. The former is dominant and decay through the capacitor is characterised by a time constant of τ=RC, where R is the insulation resistance for the capacitor. For a parallel plate capacitor of area A, dielectric gap t, dielectric constant ϵᵣϵ₀ and dielectric resistivity ρ, C=ϵᵣϵ₀A/t and R=ρt/A. Thus, in this simple model, the time constant τ=ϵᵣϵ₀ρ is independent of the capacitance. Naturally, this is just an approximation, as ρ can be affected by fabrication imperfections, which can depend on capacitor size. Still, given typical dielectric resistivities at room temperature, time constants exceeding minutes can be expected. τ~270 s have been measured for thin-film capacitors in alumina, and this number in further analysis, and reference is made to Y. Xu, F. K. Unseld, A. Corna, A. M. J. Zwerver, A. Sammak, D. Brousse, N. Samkharadze, S. V. Amitonov, M. Veldhorst, G. Scappucci, R. Ishihara, and L. M. K. Vandersypen, Applied Physics Letters 117, 144002 (2020).

Assuming τ=270 s, the duration that the electrode can remain disconnected before it needs to be recharged can be determined. The most stringent target relates not to transport, but to entangling gates: electrode voltage changes lead to stray field changes lead to motional frequency changes due to trap anharmonicities. This is particularly severe for radial modes and mixed-species crystals in surface-electrode Paul traps. As an order-of-magnitude Δf~1 kHz per V/m is used.

For entangling gates, Of should be significantly below the sideband Rabi frequency Ω′. As an order of magnitude, Δf≤100 Hz, thus a stray-field error of E≤<0.1 V/m is required. In principle, much bigger stray field changes can be tolerated, as long as they are known and accounted for in the gate drive settings.

For transport, ion splitting is the most sensitive operation, and an axial stray field error of E≤5 V/m is required for the operation to be executed successfully. However, larger stray-field drifts can be tolerated as long they are radial. Finally, errors in stray fields can lead to heating and even ion loss during transport operations such as crystal rotations or junction transport. However, these can typically tolerate errors as large as E~100 V/m.

Measurements from surface traps indicate that stray fields generally fluctuate by E~100 V/m along the trap axis, although the presence of unshielded structures can produce variations an order of magnitude larger. Furthermore, the offsets are predominately in the out-of-plane direction. Suppose that the shim electrode is used to compensate a stray field range E=200 V/m. Thus, (a) high-fidelity gates require a voltage error below ΔV/V≤0.1/200=5×10-4, (b) splitting ΔV/V≤0.1/200=2.5×10-2, and (c) other transport ΔV/V≤100/200=0.5. These numbers are rough, and the actual requirements can be significantly less stringent, depending on the trap anharmonicity, gate mode choice, sideband Rabi frequency, and whether the decay is uniform across the processor.

Nonetheless, these numbers are a useful starting point for discussing discharging timescales. Assuming τ=270 s as above, it is found that shim electrodes might require recharging every (a) 135 ms for gates (b) 7 s for splitting, (c) 3 min for transport. Thus, given the typical qubit reconfiguration timescales herein before described, unless the sideband drive can be adjusted to keep track of shifting mode frequencies, shim electrodes will likely require recharging mid-circuit, for example, between subsequent reconfigurations. On the other hand, if the gate drive can compensate for local offsets, it might be sufficient to recharge the shim electrodes between circuits only.

### IV. Quantum Operations

The approaches hereinbefore described can also help with improving qubit internal state control.

In fault-tolerant quantum computing, the problem of implementing arbitrary unitaries is reduced onto a problem of implementing a fixed set of primitive gates, for example single-qubit and two-qubit gates. Typically, quantum gates on N qubits are performed by applying O(N) signals from O(N) qubit drives (such as lasers or microwaves). Instead, however, parallel dynamic control and shim multiplexing methods can be used to implement primitive gates with only a small number of qubit drives.

The term “qubit drive” is intended, loosely, to refer to a signal source that couples to the qubit state. For example, when a laser is split into N paths, each modulated by a separate acoustic-optical modulator (AOM) and focused onto a different qubit, it can be said that there are “N individual qubit drives”. On the other hand, if a laser is modulated by a single AOM and focused onto N qubits, it can be said that there is only a single, global qubit drive. Typical qubit drives include laser light near-resonant with a qubit quadrupole transition, a pair of laser beams near-resonant with a qubit Raman transition and microwave/RF B-fields near-resonant with the qubit transition. On the other hand, DC or AC electric fields from trap electrodes typically cannot be used as qubit drives, as they only couple to the motion, not to the internal state of the ion.

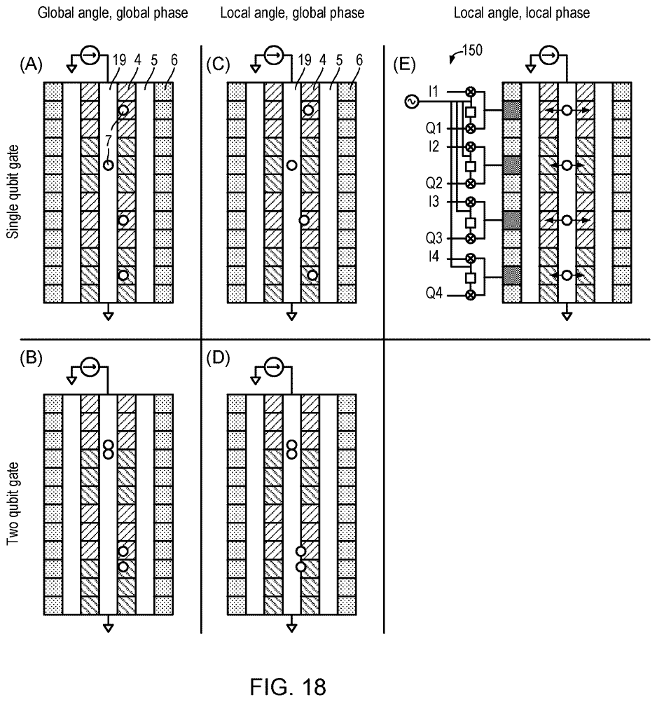

Referring to FIGS. 18A to 18E, quantum gate operation can be illustrated using an example 1D linear trap 3 with a microwave conductor 19 running along the trap axis. The conductor 19 acts as a global qubit drive, creating the same B-field and B-field gradient, near-resonant with the qubit frequency, in every zone in parallel. This leads to qubit coupling with Rabi frequency Ω(r)≈Ω₀+Ω′r, where r is the distance from the trap axis. Furthermore, for simplicity of illustration, it is assumed that Ω₀≈0, which can be achieved using multiple conductors, or by “partial nulling”, where the B-field generated is polarised in a way that avoids qubit coupling.

### A. Quantum Gates Via Parallel Dynamic Control

Referring to FIG. 18A, a method of single-qubit control is illustrated. Using parallel dynamic control, the ion 7 can be moved in every zone into one of two locations. If s=1, the ion 7 is moved to a location r₁=r, while if s=0, the ion 7 is moved into location r₀=0. The locations are selected such that, once the qubit drive is switched on, ions in location 1 experience a Rabi frequency Ω≈Ω₀+Ω′r, while ions in location 0 experience Rabi frequency Ω₀≈0. If the drive is resonant with the qubit frequency, this generates a Hamiltonian

$${H}_{ϕ} = {Σs}_{i} Ω {σ}_{ϕ}^{( i )} ,$$

where σ_{φ}=cos φσₓ+sin φσ_{y}, and φ and Ω can be tuned by adjusting the global drive phase and amplitude, respectively. If the drive is detuned from the qubits by δ>>Ω, we instead obtain a Hamiltonian H=Σᵢsᵢσ_{z}Ω²/(2δ).

Using this toolbox, any single-qubit rotation can be implemented on any subset of qubits in parallel. For example, a Hadamard gate on qubits (1, 3, 4) can be implemented by setting s₁=s₃=s₄=1 and applying H_{φ} for time t=π/(2Ω), with φ=−π/4.

Due to unavoidable experimental imperfections, it is impossible to ensure Ω₀=0, and the qubits in location 0 will always experience some residual Rabi frequency Ω₀=ε×Ω. This, if uncorrected, results in ~ε² infidelity per qubit per gate. There are several ways to mitigate this error. First, if e is known, it is possible to undo the undesired rotation with an additional layer of pulses. Second, whether or not e is known, composite pulse schemes such as SK1 or CORPSE can be used to cancel out any systematic imperfections, and reference is made to J. T. Merrill and K. R. Brown, “Progress in compensating pulse sequences for quantum computation,” (2012), arXiv:1203.6392 [quant-ph].

Referring to FIG. 18B, in a similar way, multi-qubit gates can be implemented using parallel dynamic control. There, pairs at the intersection of zones, and dynamic electrodes are used to tune the motional frequencies. If (sᵢ, sᵢ+1)=(1, 1), the motional frequency of qubit pair (i, i+1) tuned to ω₁, while if (sᵢ, sᵢ+1)=(0, 0), the motional frequency is tuned to ω₀. The global drive parameters are tuned to ω₁, that is, they generate an effective σ_{φ}Øσ_{φ} interaction when ω=ω₁, while leaving ions at motional frequency ω₁ untouched. Thus, a Hamiltonian

$$H = {Σ}_{i} \text{?} {Ω}^{′} {σ}_{ϕ}^{( 2 i - 1 )} {σ}_{ϕ}^{( 2 i )}$$

$$\text{?} \text{indicates text missing or illegible when filed}$$

is generated.

As in the single-qubit case, composite pulses can be used to suppress infidelity associated with undesired spin-motion couplings in zones where s=0.

In FIG. 18B, tuning the motional frequency is illustrated by qubit displacement from the trap axis. It is, however, possible to tune the motional frequency by adjusting shim curvatures, leaving qubit locations intact.

### B. Quantum Gates Via Shim Demultiplexing

The methods described above allow one to implement single- and multi-qubit gates in parallel, but the angle and phase of the gate are set globally. This is sufficient in the fault-tolerant regime, but in the NISQ regime, it is strongly desirable to implement parallel control where the gate parameters are locally adjustable. FIGS. 15C and 15D demonstrate how shim multiplexing can be used for that purpose.

Referring first to FIG. 18C, using shim multiplexing, the shim voltage in every zone is set to Vᵢ, resulting in a locally ion displacement rᵢ∝Vᵢ. This displacement can be directly translated into Rabi frequency as Ωᵢ≈Ω′r∝Vᵢ. Thus, shim multiplexing a Hamiltonian

$${H}_{ϕ} = {Σ}_{i} {Ω}_{i} {σ}_{ϕ}^{( i )}$$

to be implemented, where Ωᵢ is locally adjustable. This Hamiltonian allows implementation of single-qubit parallel rotations with locally adjustable angles across the processor, while using only a single qubit drive.

Referring first to FIG. 15D, likewise parallel multi-qubit gates with locally adjustable pulse angle can be implemented by locally tuning motional frequencies and orientations, implementing

$$H = {Σ}_{i} {Ω}_{i}^{′} {σ}_{ϕ}^{( 2 i - 1 )} {σ}_{ϕ}^{( 2 i )} ,$$

where Ω′ᵢ is locally adjustable. Lack of local phase control, however, constrains the use of composite pulses to reduce unknown coherent errors in these schemes.

### C. Quantum Gates Via Modulator Multiplexing

Parallel local amplitude and phase single-qubit control can be achieved by multiplexing on-chip signal modulators. Previously, emphasis has been placed on developing on-chip qubit drive modulators, such as laser amplitude modulators. Instead, qubit drives can be kept global, but locally adjust the Rabi frequency and phase using local multiplexed low-frequency voltage sources.

Referring to FIG. 15E, a possible architecture is shown, where single-qubit control is achieved by a global qubit drive in combination with local low-frequency (for example, 1-10 MHz) electric fields, generated by locally adjustable IQ mixers 150. The mixer inputs I₁, . . . , I_{N}, Q₁, . . . , Q_{N} can be controlled by multiplexing a small number of voltage sources. This can be used to implement

$$H = {Σ}_{i} {Ω}_{i} {σ}_{{ϕ}_{i}}^{( i )} ,$$

where Ωᵢ can be adjusted by tuning the amplitude of the AC electric field, and φᵢ can be adjusted by tuning the phase of the AC electric field. This Hamiltonian allows for fully parallel single-qubit control, and the resulting phase control allows for the use of composite pulses to suppress systematic calibration errors.

### D. Summary

Table I below summarises the available the single- and two-qubit control Hamiltonians for different parallelisation methods.

TABLE I
Summary and comparison of qubit control Hamiltonians available with
different gate schemes

| Scheme | 1-q Hamiltonian | 2-q Hamiltonian | Method |
|---|---|---|---|
| Global angle, local phase | ${\sum }_{i = 1}^{N} {Ω}_{i} {σ}_{ϕ}^{( i )}$ | ${\sum }_{i = 1}^{N} {s}_{2 i - 1} {Ω}^{′} {σ}_{ϕ}^{( 2 i - 1 )} {σ}_{ϕ}^{( 2 i )}$ | Parallel dynamic control |
| Local angle, global phase | ${\sum }_{i = 1}^{N} {s}_{i} Ω {σ}_{ϕ}^{( i )}$ | ${\sum }_{i = 1}^{N} {Ω}^{′} {σ}_{ϕ}^{( 2 i - 1 )} {σ}_{ϕ}^{( 2 i )}$ | Shim multiplexing |
| Local angle, local phase | ${\sum }_{i = 1}^{N} {s}_{i} Ω {σ}_{{ϕ}_{i}}^{( i )}$ | — | IQ mixer multiplexing |

While the examples presented above demonstrate parallel single- and two-qubit control in traps with global microwave gradients, these methods are equally applicable to laser-based gates. In that case, trap voltages are used to translate ions within laser beams, modifying the resulting laser intensity and thus the Rabi frequency of light-ion interactions. Furthermore, the methods can be extended to multi-qubit gates beyond two qubits.

### V. Wiring a 1000-Qubit Chip

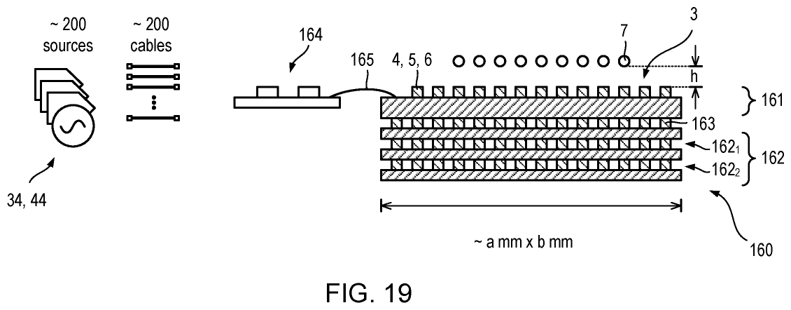

Referring to FIG. 19, an electrical wiring arrangement for an N-qubit chip 160 is shown. In this case, N=1,000. However, N may be between 100 and 1,000, or between 1,000 and 10,000 or more.

In this example, there are 10 dynamic electrodes 4 and 10 shim electrodes 6 per qubit 7 resulting in a total of 20 electrodes per qubit 7. In this case, the ion-electrode height h is about 50 μm, and a 2D layout with k=6 qubits per junction is used. In the so-called “optimal configuration”, this requires an array of m×n zones with (m, n)=(54, 19). Assuming zone size of 10h×10h (as explained in Section IIIA above), this requires a footprint of at least 27 mm×10 mm.

Dynamic operations are executed using four different zone types in a 2D architecture, each executing one of two possible actions. This requires a total of 80 off-chip voltage sources 34 (FIG. 2). The action selection is performed by sending an action select word s=(s₁, s₂, . . . , s_{N}) through a 4-wire SPI interface (not shown). Assuming SPI data streaming rate of f=50 Mb/s, the select word s can be updated in 20 μs. This is faster than the typical transport operation timescale (t₀=100 μs for a single swap), thus the SPI interface does not bottleneck the dynamic performance.

Multiplexed operations are executed by connecting each shim voltage source 44 to 128 shim electrodes 6. Thus, 10,000/128≈78 shim voltage sources 34. Each shim electrode 6 is connected to a C=30 pF on-chip capacitor 20 (FIG. 15), and all capacitors 20 can be placed on a single layer without increasing device footprint. Digital shim multiplexers 26 switch every 3 s, controlled by an on-chip shift register (not shown). Thus, shim switching only requires two external inputs, namely a 333 kHz clock (not shown) and an enable line (not shown). This is a cautious approach and the number of shim voltage sources 34 can be significantly reduced by decreasing the number of shim electrodes 6 per qubit 7 and increasing the number of shim electrodes per voltage source 44.

The core of the QPU 2 is a surface layer trap 3 which may take the form of a multi-layer surface trap.

On a top layer 161 of the trap 3, approximately 20,000 electrodes 4, 5, 6 serve to trap and transport 1,000 qubits provided by 2,000 (i.e., half encoding qubits and half used as ancillas for mid-circuit readout).

One or more buried ion trap layers 162 can be used to (a) route and deliver voltages to the top-layer electrodes, (b) route currents and deliver qubit drive B-fields and B-field gradients to the ions, (c) route lasers to the ions via integrated photonics, (d) collect and/or readout ion fluorescence. The electrode voltages are delivered via ~20, 000 vias 163 from the bottom layers 162 of the chip which implement the switch network 22. Alternatively, the switch network can be implemented on a separate chip 164, connected to the ion trap chip 3 via a high-density IC interconnect with ~20, 000 bumps (not shown). The separate chip 164 may additionally or alternatively house other circuits (not shown) providing, for example, signal conditioning, and may include DC filters, RF resonators, and microwave impedance matching circuits.

A first buried layer 162₁ (or “capacitor layer”) may include around 10, 000 thin-film planar capacitors 20 (FIG. 15), one per shim electrode 6.

A second buried layer 162₂ (or “switch layer”) may provide, for example, (a) around 10,000 dynamic electrode switches 26 (FIG. 2), for example, each made of out two transmission gates 87 (FIG. 11C), (b) around 10,000 shim electrode switches 136 (FIG. 17), for example, each made of one transmission gate, (c) a digital serial-to-parallel converter 82 (FIG. 1A) for dynamic electrode control, and (d) a digital demultiplexer 135 (FIG. 17) for shim control.

The separation of the QPU into layers of specific function, as well as the precise ordering of these layers and the stack-up, may differ from the one presented above.

Table II below summarises the electrical connections to the 1,000-qubit chip. In total, 167 wirebonds 165 suffice to perform arbitrary qubit reconfiguration in a 1,000-qubit chip. In addition to the transport voltage lines, additional electrical connections might be required to perform quantum gates. To perform laser-free quantum gates, one would additionally connect a small number (1 to 10) of current lines that generate magnetic field gradients in multiple zones across the chip at once. Furthermore, Paul traps require a small number of high-voltage inputs to generate the trapping potentials. Thus, under 200 electrical input connections suffice to control a 1000-qubit trapped ion quantum computer.

TABLE II
Electrical connects to QPU for DC electrode control in a 1,000-
qubit chip. Additional electrical connections can be used
to connect the trapping RG and on-chip current lines.

| Source | I/O count |
|---|---|
| Transport voltage sources | 80 |
| Dynamic SPI | 4 |
| Digital logic power | 3 |
| Shim voltage sources | 78 |
| Multiplexer control | 2 |
| Total | 167 |

Additional optical control can be used to perform dissipative operations such as state preparation, ion cooling, and qubit measurement. In this architecture, these operations can be executed globally, with light delivery accomplished by connecting a small number of optical fibres to the chip, and then splitting them passively between zones. Furthermore, qubit readout can be executed by integrating multiplexed photodetectors into the QPU.

### MODIFICATIONS

It will be appreciated that various modifications may be made to the embodiments hereinbefore described. Such modifications may involve equivalent and other features which are already known in the design, manufacture and use of charged particle trap apparatus and component parts thereof and which may be used instead of or in addition to features already described herein. Features of one embodiment may be replaced or supplemented by features of another embodiment.

The charged particle trap apparatus need not necessarily be a quantum information processing (or “qubit” processing) apparatus such as a quantum computer, but can be, for example, an atomic clock.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application g or of any further application derived therefrom.

1. Apparatus, comprising:
a charged particle trap including a set of electrodes for transporting charged particles;
a plurality of voltage sources, each voltage source having a respective output; and
a set of switches,
wherein each electrode in the set of electrodes is provided with a respective switch in the set of switches,
wherein each switch in the set of switches is configured to selectably connect the electrode in the set of electrodes to the output of one of the voltage sources and wherein at least two switches in the set of switches are configured to be selected together.

2. The apparatus of claim 1, wherein at least some of the electrodes in the set of electrodes form a contiguous section of a charged particle transport path in the charged particle trap.

3. The apparatus of claim 1, wherein at least some of the electrodes in the set of electrodes are spaced apart along a charged particle transport path in the charged particle trap.

4. The apparatus of claim 1, wherein the electrodes in the set of electrodes at a first time may differ from the set of electrodes at a second, different time.

5. The apparatus of claim 1, wherein each switch in the set of switches is configured to selectably connect the electrode to the output of one of two voltage sources.

6. The apparatus of claim 1, wherein each switch in the set of switches is configured to operate as a single-pole, double-throw switch.

7. The apparatus of claim 1, wherein each switch in the set of switches is configured to operate as a single-pole, multi-throw switch.

8. The apparatus of claim 7, wherein each switch in the set of switches is configured to selectably connect the electrode to the output of one of at least three voltage sources.

9. The apparatus of claim 7, wherein each switch in the set of switches is configured to selectably connect the electrode to a terminal which is grounded, tied to a given voltage, or floating.

10. The apparatus of claim 1, wherein all of the switches in the set of switches are configured to be selected together.

11. The apparatus of claim 1, wherein the switches in the set of switches are configured to be selected using at least one selection bit.

12. The apparatus of claim 1, further comprising:
a controller;
wherein the controller is configured to output at least one selection signal to the switches in the set of switches.

13. The apparatus of claim 12, wherein the controller is configured to output a selection signal to the switches in the set of switches.

14. The apparatus of claim 13, wherein the controller is configured to output at least two selection signals, each selection signal provided to a respective switch.

15. The apparatus of claim 14, wherein the controller is configured to output, at first time, at least two selection signals to at least two switches in a first set of switches and, at a second time, at least two selection signals to at least two switches in a second set of switches, wherein the first set of switches and the second set of switches differ by at least one switch.

16. The apparatus of claim 12, wherein the controller is configured to cause first and second charged particles lying in a path in the charged particle trap to be swapped.

17. The apparatus of claim 12, wherein the controller is configured to cause order of at least two charged particles lying in a path in the charged particle trap to be changed.

18. The apparatus of claim 12, wherein each of the plurality of voltage sources is configured to output a predetermined waveform, and wherein the controller is configured to output at least one selection signal so as to cause reconfiguration of at least two charged particles lying in a path in the charged particle trap.

19. The apparatus of claim 1, comprising:
a first set of electrodes and a first set of switches, wherein each electrode in the first set of switches is provided with a respective switch in the first set of switches, and wherein at least two switches, optionally all of the switches, in the first set of switches are configured to be selected together; and
a second set of electrodes and a second set of switches, wherein each electrode in the second set of switches is provided with a respective switch in the second set of switches, and wherein at least two switches, optionally all of the switches, in the second set of switches are configured to be selected together;
wherein at least one of the switches in the first set of switches and at least one of the switches in the second set of switches are connected to the same voltage sources.

20. The apparatus of claim 1, wherein:
a first electrode in the first set of electrodes is configured to be connectable to a one of a first voltage source or a second voltage source; and
a first electrode in the second set of electrodes is configured to be connectable to a one of a first voltage source or a third voltage source.

21. The apparatus of claim 1, comprising:
P sets of voltage sources, each set of voltage sources comprising Q voltage sources where P and Q each are positive, non-zero integers;
wherein each set of switches is configured to switch between a first set of the P sets of voltage sources and a second set of the P sets of voltage sources so as to connect a set of Q electrodes to either the first set of P voltage sources or to the second set of the P sets of voltage sources.

22. The apparatus of claim 1, wherein each of the voltage sources is configured to output a time-varying signal waveform.

23. The apparatus of claim 1, wherein each of the voltage sources is configured to output a respective smooth waveform for holding a charged particle at a given position or for moving a charged particle from a first position to second position along a transport path.

24. The apparatus of claim 1, wherein the set of electrodes comprises at least 3 electrodes and no more than 40 electrodes.

25. (canceled)

26. The apparatus of claim 1, comprising at least 50 electrodes and no more than 1,000,000 electrodes.

27. (canceled)

28. The apparatus of claim 1, wherein each electrode in the set of electrodes is layer-like having a thickness, and wherein each electrode has at least one dimension perpendicular to the thickness between 10 μm and 2,000 μm.

29. The apparatus of claim 1, comprising:
a charged particle trap chip;
wherein the charged particle trap and the switches are monolithically integrated on the charged particle trap chip.

30. The apparatus of claim 1, comprising:
a charged particle trap chip; and
at least one further chip stacked on the charged particle trap chip;
wherein the switches are integrated into the at least one further chip.

31. The apparatus of claim 29, wherein the voltage sources are integrated on the charged particle trap chip or the at least one further chip.

32. The apparatus of claim 1 further comprising:
a transport controller;
wherein the transport controller is configured to control the switches.

33. The apparatus of claim 1, configured to be a quantum computer.

34. The apparatus of claim 1, wherein the set of electrodes are transport electrodes and the plurality of voltage sources are a plurality of transport voltage sources, wherein the set of trap electrodes includes a set of shim electrodes for generating electric fields for manipulating charged particles, the apparatus further comprising:
a shim voltage source having an output; and
a demultiplexer having an input and a plurality of outputs, wherein the output of the shim voltage source is coupled to the input of the demultiplexer, and each of the plurality of outputs of the demultiplexer are coupled to a respective one of the set of shim electrodes;
wherein the demultiplexer is configured, in a first phase, to charge the shim electrodes sequentially and, in a second phase, to be disconnected from the shim electrodes for a given time for providing a lower noise environment in which operations can be performed on the charge particles.

35. A system comprising:
the apparatus of claim 1; and
a cryogenic system for cooling at least the charged particle trap.

36. A method of operating an apparatus the apparatus comprising:
a charged particle trap including a set of electrodes for transporting charged particles;
a plurality of voltage sources, each voltage source having a respective output; and
a set of switches,
wherein each electrode in the set of electrodes is provided with a respective switch in the set of switches,
wherein each switch in the set of switches is configured to selectably connect the electrode in the set of electrodes to the output of one of the voltage sources and wherein at least two switches in the set of switches are configured to be selected together,
wherein the method comprises:
causing an order of at least two charged particles lying in a path in the charged particle trap to be changed including causing at least two switches in the set of switches to be switched together.
